(19) United States
(12) Patent Application Publication
(10) Pub. No.: US 2007/0076953 A1
(43) Pub. Date: Apr. 5, 2007

(54) Data-encoding pattern, system and method

(76) Inventors: Andreu Gonzalez, Sant Cugat del Valles (ES); Maurizio Pilu, Stoke Gifford (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,954

(22) Filed: Jul. 25, 2006

(30) Foreign Application Priority Data
Oct. 5, 2005 (GB) 0520201.5

(51) Int. Cl. G06K 9/00; G06K 7/10

(52) U.S. Cl. 382/188; 235/454

(57) ABSTRACT

A data encoding pattern comprising a plurality of markings respectively composed from at least two sub-markings, wherein the colour of respective ones of the sub-markings and their arrangement for a marking is reserved.

### CLAIM TO PRIORITY

This application claims priority from co-pending United Kingdom utility application entitled, “Data-Encoding Pattern System and Method” having serial no. GB 0520201.5, filed Oct. 05, 2005, which is entirely incorporated herein by reference.

### FIELD OF THE INVENTION

The present invention relates generally to a data encoding pattern, and more specifically, but not exclusively, to an optically detectable pattern for use with a digital pen and paper system.

### BACKGROUND

Many digital pen and paper type systems have been proposed. One that is in use is the Anoto system, which can be implemented using a device such as the Logitech IO2 pen, available from Logitech of 6505 Kaiser Drive, Fremont, Calif. 94555, USA. Generally, using such technology, the pen acting as detector senses a position determining pattern that has been printed onto a page and an evaluation of the pen's position, and movements, is made using data collected by the pen.

WO 03/046708 discloses a system of this kind. In the known Anoto type arrangements, the pen is connected by a Universal Serial Bus (USB) cable or wirelessly to a processing device such as a mobile telephone or a personal computer. The processing device receives data from the pen and can identify the document which has been marked by the pen. This can result in the processing device determining information about how the document should be handled. This information may identify an application, perhaps stored on the processing device or held remotely, which enables the information from the pen to be processed.

In order for systems such as those described above to function correctly, a position encoding pattern printed on the digital paper must be discernable from other content such as text or images for example. A typical solution is to print the encoding pattern and the content using different inks. For example, the data encoding pattern can be printed using infra-red or ultraviolet ink which can only be sensed using a suitable sensor, and which is not affected by over printing with another IR transparent ink which is detectable in the visible region of the spectrum. This enables the detector to detect the pattern using light at a wavelength that is absorbed or reflected by the pattern but not the content, or by the content and not the pattern. US20050063000 (Silverbrook) describes a printer for printing an interface onto a surface using a complementary ink set.

However, this requires the use of two different inks, which can add to the complexity of the printing process. Furthermore, the large number of users with standard printers requires a more generic solution. For example, the space of existing installed printers requires a solution which does not necessitate a printer to be modified.

### SUMMARY OF THE PRESENT INVENTION

According to a first aspect of the present invention there is provided a data encoding pattern comprising a plurality of markings respectively composed from at least two sub-markings, wherein the colour of respective ones of the sub-markings and their arrangement for a marking is reserved.

According to a second aspect of the present invention there is provided a method of encoding data using a pattern suitable for applying to a product, the method comprising, analysing content to be applied to the product, and applying the content and pattern to the product, a marking for the pattern composed of at least two sub-markings, wherein a colour combination and arrangement of sub- markings for a marking is a reserved combination.

### BRIEF DESCRIPTION OF THE FIGURES

For a better understanding of the present invention, and to further highlight the ways in which it may be brought into effect, embodiments will now be described, by way of example only, with reference to the following drawings in which:

FIG. 1 is a schematic representation of a product comprising a data encoding pattern and content;

FIG. 2 is schematic representation of a portion of an exemplary data encoding pattern;

FIG. 3 is a schematic representation of a detector for use with the product of FIG. 1; and

FIG. 4 is a schematic representation of a portion of a marking pattern according to an embodiment.

It should be emphasised that the term “comprises/comprising” when used in this specification specifies the presence of stated features, integers, steps or components but does not preclude the presence or addition of one or more other features, integers, steps, components or groups thereof.

### DETAILED DESCRIPTION OF PREFERRED EMBODIMENTS

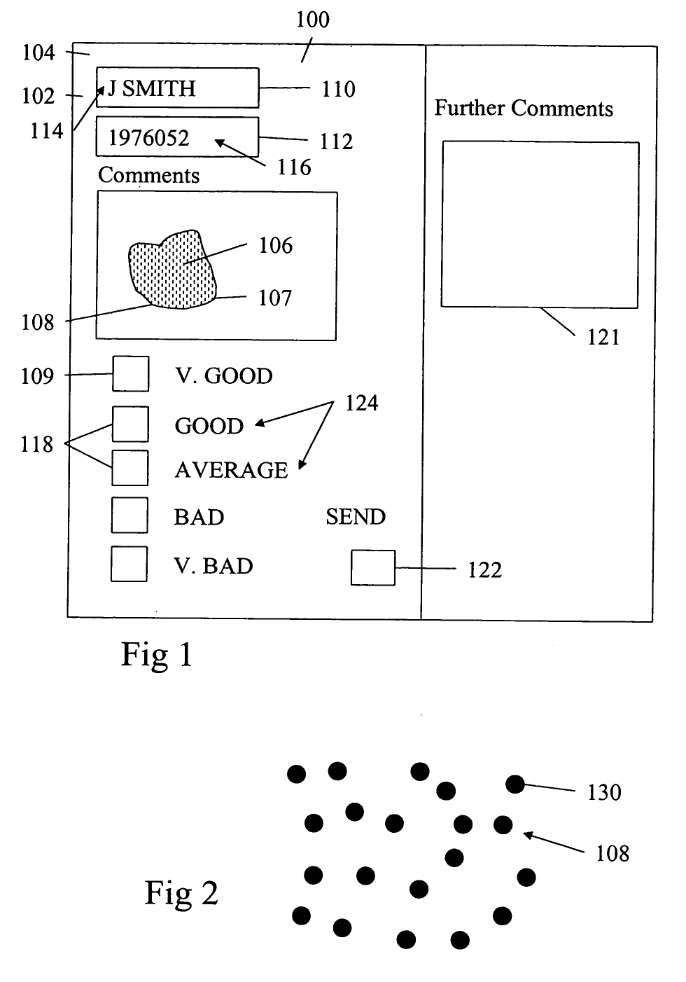

Referring to FIG. 1, a document 100 for use in a digital pen and paper system comprises a carrier 102 in the form of a single sheet of paper 104 with position identifying markings 106 printed on some parts of it to form areas 107 of a position identifying pattern 108. Also printed on the paper 104 are further markings 109 which are clearly visible to a human user of the form, and which make up the content of the document 100. The content 109 will obviously depend entirely on the intended use of the document. The content, format or use of the document described with reference to FIG. 1 is not intended to be limiting.

In this case an example of a very simple questionnaire document is shown. The content comprises a number of boxes 110, 112 which can be pre-printed with user specific information such as the user's name 114 and a document identification number 116. The content further comprises a number of check boxes 118 any one of which can be marked by a user, and two larger boxes 120, 121 in which the user can write comments, as well as some printed text and images. The form content also comprises a send box 122 which can be checked by the user when they have completed the questionnaire. When ticked or marked, this can initiate a document completion process by which pen stroke data and typographical information on the form such as the headings or labels 124 for the various boxes 110, 112, 118, 120 is forwarded for processing for example.

A position identifying pattern 108 can be printed onto the parts of the form which the user is expected to write on or mark, within the check boxes 118, the comments boxes 120, 121 and the send box 122 for example, or over the entire page.

Referring to FIG. 2, an exemplary position identifying pattern 108 is made up of a number of markings 130. The arrangement of the markings defines an imaginary pattern space, and only a small part of the pattern space need be taken up by the pattern on the document 100. By allocating a known area of the pattern space to the document 100, for example by means of a co-ordinate reference, the document and any position on the patterned parts of it can be identified from the pattern printed on it. It will be appreciated that many position identifying patterns can be used. Some examples of suitable patterns are described in WO 00/73983, WO 01/26033 and WO 01/71643 for example.

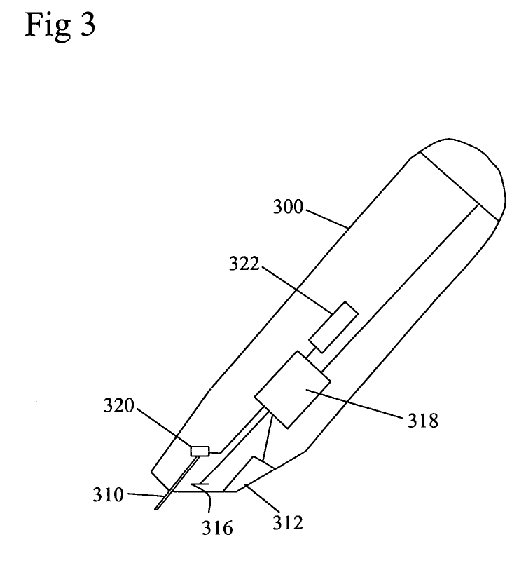

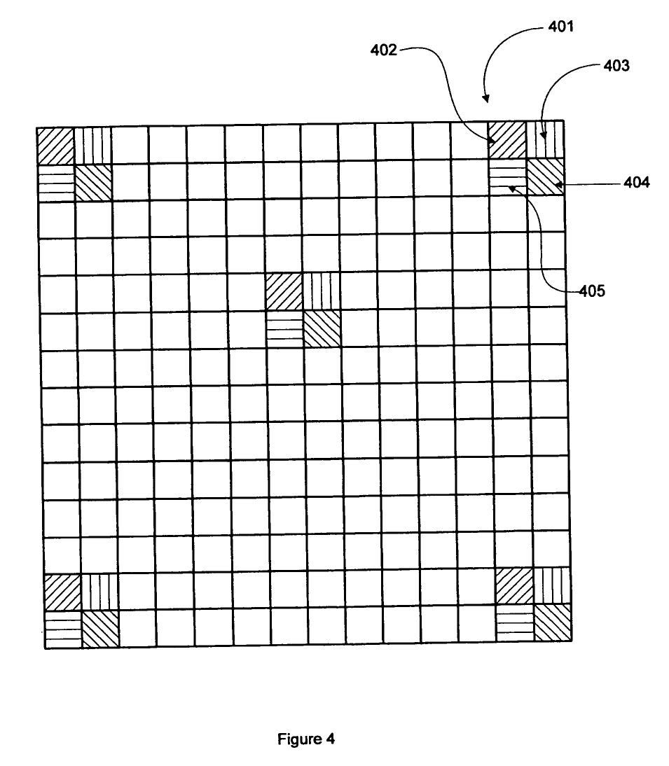

Referring to FIG. 3, a digital pen 300 comprises a writing stylus 310, and a camera 312. The camera 312 is arranged to image an area adjacent to the tip 311 of the pen stylus 310. A processor 318 processes images from the camera 312. A pressure sensor 320 detects when the stylus 310 is in contact with the document 100 and triggers operation of the camera 312. Whenever the pen is being used on a patterned area of the document 100, the processor 318 can therefore determine from the pattern 108 the position of the stylus of the pen whenever it is in contact with the document 100. From this it can determine the position and shape of any marks made on the patterned areas of the document 100. This information is stored in a memory 322 in the pen as it is being used.

The pen can be provided with an output port which can comprise at least one electrical contact that connects to corresponding contacts on a base station (not shown). Alternatively, the pen and base station can communicate wirelessly using an infra-red or radio frequency communications link such as Wi-Fi or Bluetooth for example. Other alternatives are possible.

Although reference is made herein to a digital pen (and paper system) comprising a camera this is not intended to be limiting, as it will be appreciated that all which is required in order to effectively image a pattern is an image capturing device. Such a device can be incorporated into a number of products, not just a pen. For example, an image capture device can be incorporated into a mobile station such as a mobile telephone or pager, or in a personal digital assistant.

According to an embodiment, a marking for a data encoding pattern can be comprised from at least two constituent sub-markings, such as dots for example. Each sub-marking can therefore be composed from a dot from a printer, such as an inkjet or laser printer for example, depending on the desired resolution. Advantageously, each sub-marking is a different colour, taken from a set of primary print colours such as CMYK, or RGB for example. The combination of colours used to define a marking is therefore provided at the sub-marking level, and the combination of colours used for a marking forms a reserved set. More specifically, the colours of the sub-markings, and their disposition within a marking are reserved in the sense that content is restricted from using those colours in the specific disposition used for the markings. This provides a way of ensuring that a marking can be detected since knowledge of the marking colours and their arrangement is known. Hence, when such an arrangement is detected, it must form part of the pattern as the content has been restricted from using such an arrangement.

Alternatively, a marking can be composed from at least two sub-markings, with each sub-marking being composed from the same colour. The combination of colours used to define a marking is therefore provided at the pattern level, i.e. there is one colour per marking and a specific arrangement of markings of different colours defines a ‘super-marking’ which can be detected. Each marking can be defined by one or more pixels at the desired resolution.

FIG. 4 is a schematic representation of a portion of a marking pattern according to an embodiment. A marking 401 for a pattern 108 is composed from a number of sub-markings 402,403,404,405. Different colours for the sub-markings are schematically represented by the respective different hatching for the sub-markings. Marking 401 comprises four sub-markings—more or less can be used, providing that at least two are used, the two or more sub-markings having respective different colours.

The colours from which sub-markings are composed can be from the CYMK subtractive colour space, or any other suitable colour space such as RGB for example, or a combination of the two. When colours from the CYMK colour space are used, it will be appreciated that, in general, a typical printer driver sends print data to the printing device in the RGB colour space. In order to perform a suitable colour space conversion Postscript embedding functionality can be used for example.

With reference to FIG. 4, the combination of colours provided by 402,403,404,405 form a marking for pattern 108. The colours of sub-markings 402,403,404,405 and their arrangement form a reserved combination. The reserved combination is optically detectable with respect to the rest of the content upon which it is printed. As explained, the combination 402,403,404,405 is reserved in the sense that content to be printed to the product in question does not comprise any regions in which the reserved combination of colours occurs in the desired arrangement. Consequently, any detection of the reserved combination must be from a marking of the pattern. In the unlikely event that a portion of the content does comprise the reserved combination of colours in the arrangement of a marking, the colours from the portion can be replaced with similar colours which are not part of the reserved combination. The visual effect of the replacement is therefore minimal. The provision of ensuring that a selected combination of colours does not occur in the content can be effected in a number of ways. For example, prior to printing of the pattern and content to a product, such as a carrier, data representing the content to be printed can be reviewed and, if necessary processed in order to substitute a reserved combination of colours for another similar combination. Advantageously the marking is invariant under rotation, specifically at 90, 180 and 270 degrees.

Content and pattern data can be analysed using a suitable processor of a computing device or printer for example, and any analysis can be carried out immediately prior to printing, on the fly (i.e. as content is being printed), or prior to printing—for example, content can be analysed remotely and results can be transmitted wirelessly or using a wired link (via the internet for example). Other alternatives are possible.

Alternatively, empty (blank) pixels can surround a marking. In this way, the probability that a portion of content will comprise the same colour combination is very low for a limited pattern area in the field of view of a detector such as that described above with reference to FIG. 3.

Detection of a pattern can be performed, after suitable colour space conversion, by a colour camera (e.g. RGB). The camera can be integral to a detector such as a digital pen or other suitable device. The unique pattern configuration can be detected using a variety of pattern matching techniques.

In a preferred embodiment, a 3×3 neighbourhood of, for example with reference to FIG. 4, every black sub-marking (dot) can be analysed. Neighbouring sub-markings can then be classified probabilistically as C,Y,M and/or K. A Bayes classifier, for example, can then be used to classify each of the four 2×2 cliques in the 3×3 neighbourhood against an expected model for the coloured patters and its rotated version. A probability value of the pattern existing at a location can be contrasted with the neighbours and thresholded to finally yield a positive marker's detection and location.

Advantageously, all inks of a printing device can be used for all types of input data, regardless of whether they are intended to be machine-readable or human-readable. Further, the colour palette that can be applied to contents on top of pattern need not be limited (no need of form redesign). The described method and system can ensure that pattern and content are separable. A better appearance of images can be obtained in image pre-filling when on top of a pattern, since a pattern is composed of primary colours, all that is required is to ensure that the unique combination is not employed in content, but it can contain as much black as needed, thus maintaining original contrast.

1. A data encoding pattern comprising a plurality of markings respectively composed from at least two sub-markings, wherein the colour of respective ones of the sub-markings and their arrangement for a marking is reserved.

2. A data encoding pattern as claimed in claim 1, wherein markings are arranged in a specific disposition such that data is encoded by the pattern by virtue of the disposition of markings.

3. A data encoding pattern as claimed in claim 1, wherein the colours for respective ones of the sub-markings are pre-determined.

4. A data encoding pattern as claimed in claim 1, wherein a colour for a sub-marking is selected from the CYMK or RGB colour space.

5. A method of encoding data using a pattern suitable for application to a product or article, the method comprising:
analysing content to be applied to the product; and
applying the content and pattern to the product, a marking for the pattern composed of at least two sub-markings, wherein a colour combination and arrangement of sub-markings for a marking is a reserved combination.

6. A method as claimed in claim 5, wherein data is encoded using the pattern by virtue of the arrangement of the markings.

7. A method as claimed in claim 5, wherein analysing content to be applied to the product comprises determining if there are any portions of the content comprising the reserved colour combination.

8. A method as claimed in claim 5, wherein the reserved combination is selected from colour from at least one of the CMYK and RGB colour spaces.

9. A method as claimed in claim 5, wherein the reserved combination is a specific arrangement of colours of sub-markings which does not occur in the content.

10. A method as claimed in claim 7, further comprising adjusting a portion of the content in order to ensure that a colour combination for the portion does not comprise the reserved combination.

11. A printing device operable to print a pattern as claimed in any of claim 1 to a product.

12. A printing device as claimed in claim 10, further comprising a processor operable to analyse a content to be printed to the product, and, on the basis of the analysis, adjust a portion of the content in order to ensure that a colour combination for the portion does not comprise the reserved combination.
